(19) United States
(12) Patent Application Publication
(10) Pub. No.: US 2008/0301793 A1
(43) Pub. Date: Dec. 4, 2008

(54) APPARATUS AND METHOD OF VERIFYING ONLINE CERTIFICATE FOR OFFLINE DEVICE

(75) Inventors: Yeo-jin Kim, Suwon-si (KR); Sang-gyoo Sim, Suwon-si (KR); Yun-sang Oh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/045,229

(22) Filed: Mar. 10, 2008

(30) Foreign Application Priority Data
May 28, 2007 (KR) 10-2007-0051572

(51) Int. Cl. H04L 9/32

(52) U.S. Cl. 726/10

(57) ABSTRACT

An apparatus and a method are provided for verifying an online certificate for an offline device. The apparatus includes a nonce generation unit which generates a nonce and a certificate verification request message that requests verification of a certificate on a target online device subject to authentication, wherein the certificate verification request message includes the generated nonce; a transmitting and receiving unit which transmits the certificate verification request to an online device and receives an online certificate status protocol (OCSP) response message from the online device; and a certificate verification result determination unit which extracts a nonce from the OCSP response and compares the extracted nonce with the nonce generated by the nonce generation unit to determine whether the OCSP response is reliable.

### CROSS REFERENCE TO RELATED APPLICATION

This application claims priority from Korean Patent Application No. 10-2007-0051572 filed on May 28, 2007 in the Korean Intellectual Property Office, the disclosure of which is incorporated herein by reference in its entirety.

### BACKGROUND OF THE INVENTION

1. Field of the Invention

Methods and apparatuses consistent with the present invention relate to verifying an online certificate for an offline device, and in particular, to allowing an offline device to use an online certificate status protocol (OCSP) to thereby authenticate an online device.

2. Description of the Related Art

The OCSP is a protocol that allows an online or connected device to authenticate the status of a certificate of another device. The OCSP is designed only for the online device, without consideration for an offline (unconnected) device.

The online device may be, but is not limited to, a host which provides the network connection, and the offline device may be, but is not limited to, a security card which does not provide the network connection.

In order to verify the reliability of the online device, the offline device may request an OCSP response server (responder) to verify the status of a certificate on the online device. Here, the OCSP response server stores the status of the issued certificates and reports the status of a corresponding certificate according to an OCSP request of a client.

The offline device cannot be directly connected to the OCSP response server without providing the network connection. However, the offline device can be interconnected to the OCSP response server through the online device or with support of the online device. Without verification of the online device, the offline device cannot rely on the OCSP request by the online device and therefore the response resulting from the OCSP request. In particular, the online device may store the OCSP response result before a certificate of a specific device is revoked; replay the OCSP response result previously stored after the certificate of the corresponding device is revoked; and respond to the offline device as if the revoked certificate of the corresponding device is still valid. This is known as a replay attack.

The online device can prevent a replay attack. In this case, however, only a section between the online device and the OCSP response server is reliable, and it is impossible to prevent forgery that may occur between the offline device and the online device.

### SUMMARY OF THE INVENTION

The present invention provides an apparatus and method of verifying an online certificate for an offline device that makes a response result of an OCSP response server reliable by causing an offline device to generate a nonce and add the generated nonce to an OCSP request message and an OCSP response message regarding a target online device subject to authentication.

According to an aspect of the invention, there is provided an apparatus for verifying an online certificate for an offline device, the apparatus including a nonce generation unit generating a nonce and a certificate verification request message that includes the generated nonce and requests verification of a certificate on a target online device subject to authentication, a transmitting/receiving unit transmitting the certificate verification request message to an online device and receiving an OCSP response message from the online device, and a certificate verification result determination unit extracting a nonce from the received message and comparing the extracted nonce with the generated nonce to determine whether the received message is reliable.

According to another aspect of the invention, there is provided an apparatus for verifying an online certificate for an offline device, the apparatus including a message generation unit generating an OCSP request message according to a certificate verification request message that requests verification of a certificate on a target online device received from the offline device, and a transmitting/receiving unit transmitting the generated message to an OCSP response server and receiving an OCSP response message from the OCSP response server.

According to still another aspect of the invention, there is provided an apparatus for verifying an online certificate for an offline device, the apparatus including a verification unit verifying a certificate on a target online device according to an OCSP request message received from an online device, a response message generation unit generating an OCSP response message based on the verification result, and a transmitting/receiving unit transmitting the generated message to the online device.

According to yet still another aspect of the invention, there is provided a method of verifying an online certificate for an offline device, the method including generating a nonce, generating a certificate verification request message that includes the generated nonce and requests verification of a certificate on a target online device subject to authentication, transmitting the certificate verification request message to an online device, receiving an OCSP response message from the online device, and extracting a nonce from the received message and comparing the extracted nonce with the generated nonce to determine whether the received message is reliable.

According to yet still another aspect of the invention, there is provided a method of verifying an online certificate for an offline device, the method including receiving a certificate verification request message that requests verification of a certificate on a target online device from the offline device, generating an OCSP request message according to the certificate verification request message, transmitting the OCSP request message to an OCSP response server, and receiving an OCSP response message from the OCSP response server.

According to yet still another aspect of the invention, there is provided a method of verifying an online certificate for an offline device, the method including verifying a certificate on a target online device according to an OCSP request message received from an online device, generating an OCSP response message based on the verification result, and transmitting the generated message to the online device.

### BRIEF DESCRIPTION OF THE DRAWINGS

The above and other aspects of the present invention will become more apparent from the following detailed description of the exemplary embodiments, with reference to the attached drawings in which:

FIG. 1 is a diagram illustrating a system having an apparatus for verifying an online certificate for an offline device according to an exemplary embodiment of the invention;

FIG. 2 is a diagram illustrating an online certificate verification process by the system shown in FIG. 1;

FIG. 3 is a diagram illustrating the configuration of an apparatus for verifying an online certificate for an offline device according to an exemplary embodiment of the invention;

FIG. 4 is a diagram illustrating the configuration of an apparatus for verifying an online certificate for an offline device according to another exemplary embodiment of the invention;

FIG. 5 is a diagram illustrating the configuration of an apparatus for verifying an online certificate for an offline device according to another exemplary embodiment of the invention; and

FIG. 6 is a flowchart illustrating an online certificate verification process according to an exemplary embodiment of the invention offline device.

### DETAILED DESCRIPTION OF EXEMPLARY EMBODIMENTS

Advantages and features of the present invention and methods of accomplishing the same may be understood more readily by reference to the following detailed description of exemplary embodiments and the accompanying drawings.

The present invention may, however, be embodied in many different forms and should not be construed as being limited to the exemplary embodiments set forth herein. Rather, these embodiments are provided so that this disclosure will be thorough and complete and will fully convey the concept of the present invention to those skilled in the art, and the present invention will only be defined by the appended claims.

Like reference numerals refer to like elements throughout the specification.

The invention will be described hereinafter with reference to block diagrams or flowchart illustrations of an apparatus and method of verifying an online certificate for an offline device according to an exemplary embodiment thereof.

It will be understood that each block of the flowchart illustrations, and combinations of blocks in the flowchart illustrations can be implemented by computer program instructions.

These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block may represent a module, segment, or portion of code, which comprises one or more executable instructions for implementing the specified logical function(s).

It should also be noted that in some alternative implementations, the functions noted in the blocks may occur out of order.

For example, two blocks shown in succession may in fact be executed substantially concurrently or the blocks may sometimes be executed in reverse order depending upon the functionality involved.

Hereinafter, exemplary embodiments of the invention will be described in detail with reference to the accompanying drawings.

For reference, a nonce is a value that is added to the message in order to verify the integrity of the message. The nonce is used to allow a transmission subject of a message to confirm whether the value in the message is received unchanged, thereby confirming whether a response is reliable.

The above-described nonce may be, but is not limited to, a random number. For example, a numeral or a character according to a specific rule or a counter value, such as a time stamp, may be used.

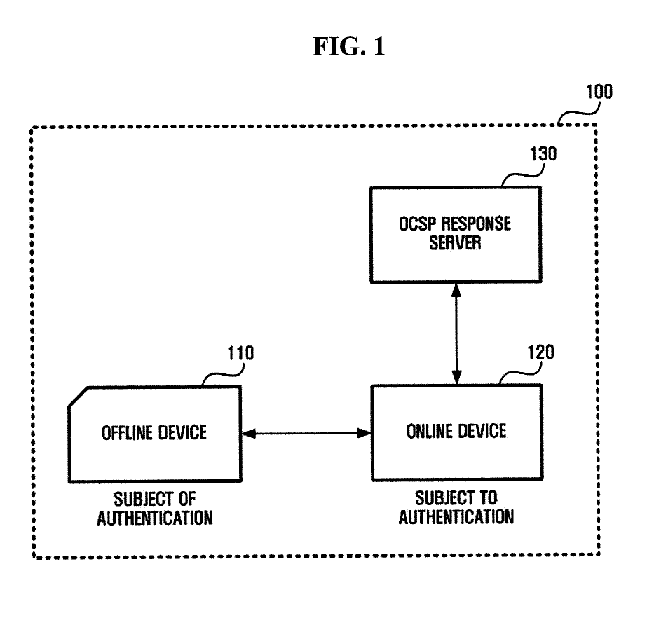

FIG. 1 is a diagram showing a system having an apparatus for verifying an online certificate for an offline device according to an exemplary embodiment of the invention.

A system 100 includes an offline device 110, an online device 120, and an OCSP response server 130. The offline device 110 generates a nonce and an online device certificate verification request message including the generated nonce, and transmits the online device certificate verification request message. The online device 120 generates an OCSP request message according to a certificate verification request message requesting verification of a certificate on a target online device received from the offline device 110 and transmits the generated OCSP request message to the OCSP response server 130. The OCSP response server 130 verifies a certificate on the target online device according to the OCSP request message received from the online device 120, generates an OCSP response message based on the verification result, and transmits the generated OCSP response message to the online device 120.

For reference, if the offline device 110 is a high-performance device that can directly generate the OCSP request message, the online device 120 does not generate an additional OCSP request message, and transmits, to the OCSP response server 130, the OCSP request message received from the offline device 110. The OCSP request message generated by the offline device 110 includes the nonce generated by the offline device 110.

On the other hand, if the offline device 110 is a low-performance device that cannot directly generate the OCSP request message, the online device 120 receives the online device certificate verification request message from the offline device 110, and generates the OCSP request message that is to be transmitted to the OCSP response server 130. The online device certificate verification request message transmitted from the offline device 110 to the online device 120 includes the nonce generated by the offline device 110. Then, the online device 120 extracts the nonce from the online device certificate verification request message that is received from the offline device 110, generates the OCSP request message, and transmits the OCSP request message to the OCSP response server 130.

According to an exemplary embodiment of the invention, the online device certificate verification request message that is transmitted from the offline device 110 to the online device 120 preferably, but not necessarily, includes at least one of the online device certificate verification request message that includes the nonce generated by the offline device 110 and the OCSP request message that includes the nonce generated by the offline device 110.

Further, the OCSP response message generated by the OCSP response server 130 may include the nonce generated by the offline device 110. In this case, the nonce can be extracted from the OCSP request message received from the online device 120.

Subsequently, the online device 120 that receives the OCSP response message transmitted from the OCSP response server 130 transmits the OCSP response message to the offline device 110. Then, the offline device 110 receives the OCSP response message and extracts a nonce from the received message.

Next, the offline device 110 compares the extracted nonce with the nonce generated by the offline device 110 to determine whether the received message is reliable. When the extracted nonce and the nonce generated by the offline device 110 are consistent with each other, it is determined that the received message is reliable.

As described above, the offline device 110 can directly generate the OCSP request message, or can request the online device 120 to generate the OCSP request message according to the performance level of the offline device 110.

The offline device does not need to directly generate the OCSP request message, but it should be of enough performance to confirm the OCSP response message. Here, the confirmation of the response message means that the offline device extracts the nonce from the OCSP response message and compares the extracted nonce with the nonce generated by its own to determine whether they are consistent with each other.

Hereinafter, it is assumed that the offline device 110 used herein is a device that cannot directly generate the OCSP request message but at a minimum, is able to confirm the OCSP response message.

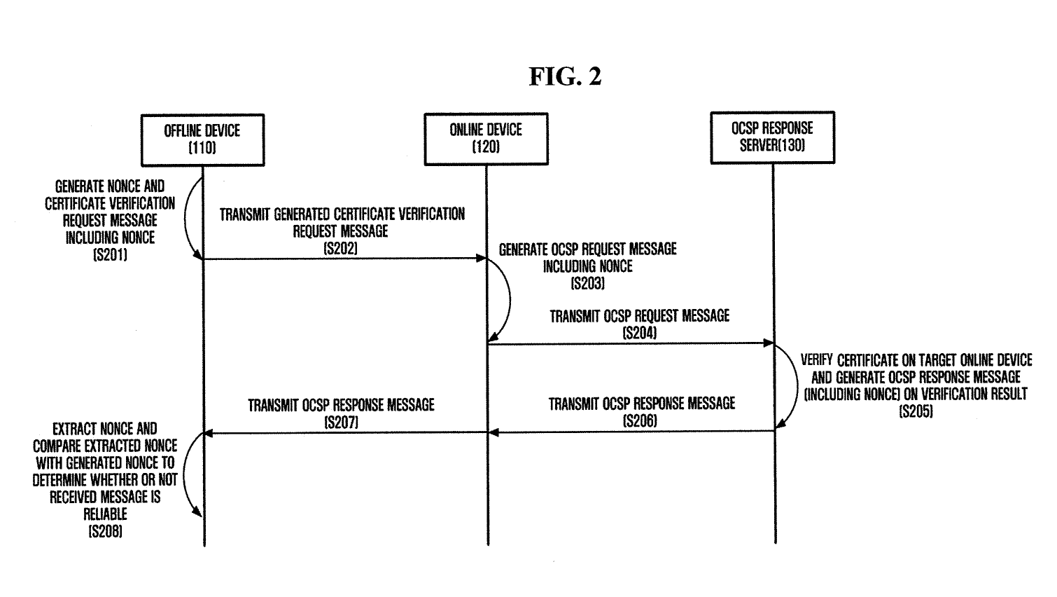

FIG. 2 is a diagram illustrating an online certificate verification process using the system shown in FIG. 1.

For convenience of explanation, a description will be given with reference to the system 100 shown in FIG. 1.

First, the offline device 110 generates a nonce and a certificate verification request message, which includes the generated nonce, requesting verification of a certificate on a target online device subject to authentication (Operation S201).

After Operation S201, the offline device 110 transmits the certificate verification request message to the online device 120 (Operation S202).

After Operation S202, the online device 120 generates the OCSP request message according to the certificate verification request message received from the offline device 110 (Operation S203).

After Operation S203, the online device 120 transmits the OCSP request message to the OCSP response server 130 (Operation S204).

At this time, the OCSP request message generated by the online device 120 may include the nonce generated by the offline device 110.

After Operation S204, the OCSP response server 130 verifies the certificate on the target online device and generates the OCSP response message based on the verification result (Operation S205).

After Operation S205, the OCSP response server 130 transmits the OCSP response message to the online device 120 (Operation S206).

The OCSP response message generated by the OCSP response server 130 includes the verification result of the certificate on the target online device and the nonce generated by the offline device 110.

For reference, the OCSP response server 130 can extract the nonce from the OCSP request message received from the online device 120.

After Operation S206, the online device 120 receives the OCSP response message and transmits the received message to the offline device 110 (Operation S207).

After Operation S207, the offline device 110 extracts the nonce from the received OCSP response message and compares the extracted nonce with the nonce generated by the offline device 110 to determine whether the verification result is reliable (Operation S208).

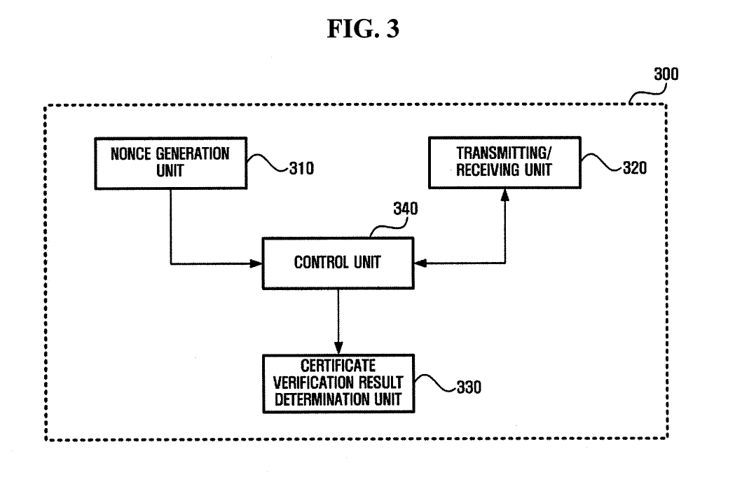

FIG. 3 is a diagram showing the configuration of an apparatus for verifying an online certificate for an offline device according to an exemplary embodiment of the invention.

For reference, the apparatus 300 shown in FIG. 3 may be incorporated into the offline device 110 of the system 100 shown in FIG. 1. For convenience of explanation, a description will be given with reference to the system 100 shown in FIG. 1.

The apparatus 300 includes a nonce generation unit 310, a transmitting/receiving unit 320, a certificate verification result determination unit 330, and a control unit 340. The nonce generation unit 310 generates a nonce and a certificate verification request message, which includes the generated nonce, requesting verification of a certificate on a target online device subject to authentication. The transmitting/receiving unit 320 transmits the certificate verification request message generated by the nonce generation unit 310 to the online device 120 and receives an OCSP response message regarding the target online device from the online device 120. The certificate verification result determination unit 330 extracts a nonce from the OCSP response message received by the transmitting/receiving unit 320 and compares the extracted nonce with the nonce generated by the nonce generation unit 310 to determine whether the received OCSP response message is reliable. The control unit 340 controls the above-described units. When a result of the comparison indicates that the nonce extracted from the message received by the transmitting/receiving unit 320 and the nonce generated by the nonce generation unit 310 are consistent with each other, the certificate verification result determination unit 330 determines that the verification result of the certificate on the target online device is reliable.

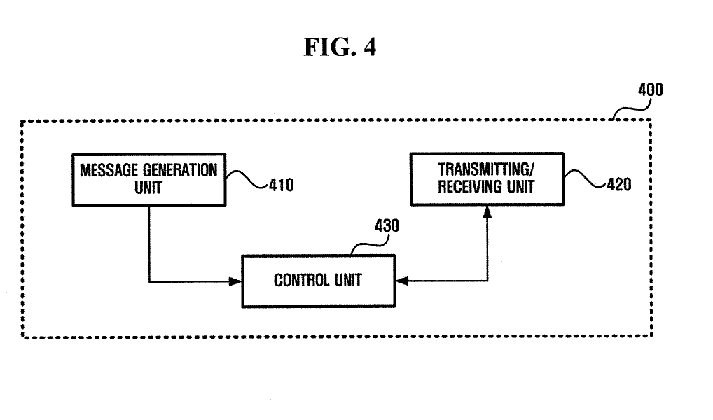

FIG. 4 is a diagram showing the configuration of an apparatus for verifying an online certificate for an offline device according to another exemplary embodiment of the invention.

For reference, an apparatus 400 shown in FIG. 4 may be incorporated into the online device 120 of the system shown in FIG. 1. For convenience of explanation, a description will be given with reference to the system 100 shown in FIG. 1.

The apparatus 400 includes a message generation unit 410, a transmitting/receiving unit 420, and a control unit 430. The message generation unit 410 generates an OCSP request message according to a certificate verification request message requesting verification of a certificate on a target online device subject to authentication received from the offline device 110. The transmitting/receiving unit 420 transmits the OCSP request message generated by the message generation unit 410 to the OCSP response server 130, and receives the OCSP response message transmitted from the OCSP response server 130. The control unit 430 controls the above-described units.

For reference, the online device 120 of the system 100 shown in FIG. 1 and the target online device that is subject to authentication by the offline device 110 may be the same device or different devices. In this exemplary embodiment, it is assumed that the online device 120 and the above-described target online device are the same device.

The OCSP request message that is generated by the message generation unit 410 of the apparatus 400 shown in FIG. 4 may include the nonce generated by the nonce generation unit 310 of the offline device 110. Then, the transmitting/receiving unit 420 transmits the OCSP response message received from the OCSP response server 130, that is, the verification result of the certificate on the target online device, to the offline device 110.

At this time, the OCSP response message that is transmitted from the transmitting/receiving unit 420 to the offline device 110 includes the verification result of the certificate on the target online device generated by the OCSP response server 130 and the nonce generated by the nonce generation unit 310 of the offline device 110.

The online device 120 may perform a replay attack. Specifically, the online device 120 may store the OCSP response message received from the OCSP response server 130 before a certificate of a specific device is revoked, replay the OCSP response message previously stored therein after the certificate of the corresponding device is revoked, and respond to the offline device 110 as if the revoked certificate of the corresponding device is still valid. In this case, the nonce included in the OCSP response message subjected to a replay attack is different from the nonce that is included in the certificate verification request message, which is transmitted from the offline device 110 to the online device 120. Accordingly, the offline device 110 determines that the corresponding OCSP response message is unreliable.

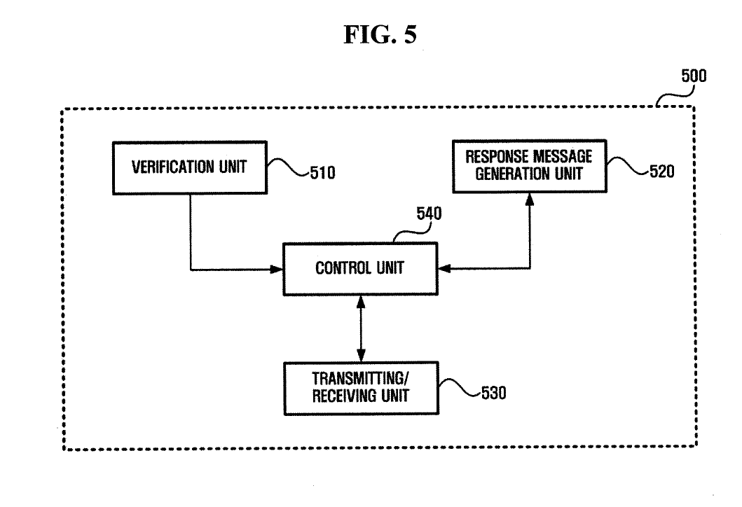

FIG. 5 is a diagram showing the configuration of an apparatus for verifying an online certificate for an offline device according to still another exemplary embodiment of the invention.

For reference, an apparatus 500 shown in FIG. 5 may be incorporated into the OCSP response server 130 of the system 100 shown in FIG. 1. For convenience of explanation, a description will be given with reference to the system 100 shown in FIG. 1.

The apparatus 500 includes a verification unit 510, a response message generation unit 520, a transmitting/receiving unit 530, and a control unit 540. The verification unit 510 verifies a certificate on a target online device according to an OCSP request message received from the online device 120. The response message generation unit 520 generates an OCSP response message based on the verification result by the verification unit 510. The transmitting/receiving unit 530 transmits the OCSP response message to the online device. The control unit 540 controls the above-described units.

The OCSP response message that is generated by the response message generation unit 520 of the apparatus shown in FIG. 5 includes the verification result of the certificate on the target online device and the nonce generated by the nonce generation unit 310 of the offline device 110. Then, the response message generation unit 520 can extract the nonce from the OCSP request message received from the online device 120.

The individual components shown in FIGS. 3 to 5 according to exemplary embodiments of the invention may include, but are not limited to, a software or hardware component, such as a Field Programmable Gate Array (FPGA) or Application Specific Integrated Circuit (ASIC), which performs certain tasks.

The component may advantageously be configured to reside on the addressable storage medium and configured to be executed on one or more processors.

Thus, the component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The functionality provided for in the components and modules may be combined into fewer components and modules or further separated into additional components and modules.

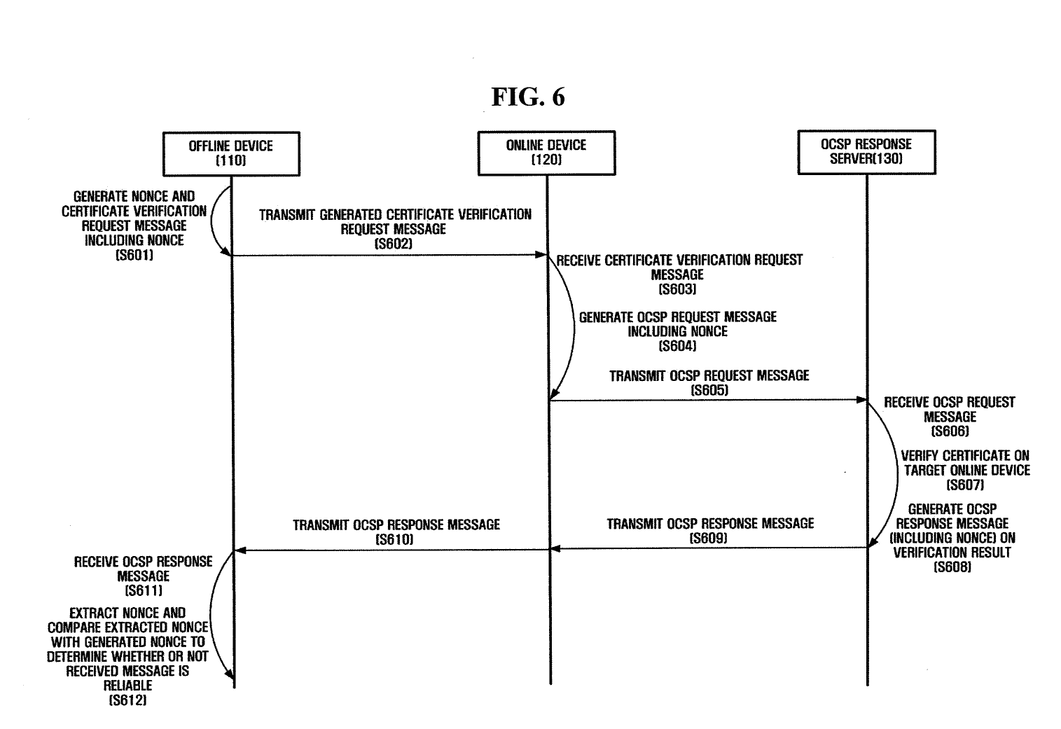

FIG. 6 is a flowchart illustrating a process of verifying an online certificate for an offline device according to an exemplary embodiment of the invention.

For reference, the apparatus 300 shown in FIG. 3 can be executed in the offline device 110 of the system 100 shown in FIG. 1. The apparatus 400 shown in FIG. 4 can be executed in the online device 120 of the system 100 shown in FIG. 1. The apparatus 500 shown in FIG. 5 can be executed in the OCSP response server 130 of the system 100 shown in FIG. 1.

For convenience of explanation, a description will be given with reference to the system 100 shown in FIG. 1.

First, the nonce generation unit 310 of the offline device 110 generates a nonce and a certificate verification request message, which includes the generated nonce, requesting verification of a certificate on a target online device subject to authentication (Operation S601).

After Operation S601, the transmitting/receiving unit 320 of the offline device 110 transmits the generated message to the online device 120 (Operation S602).

After Operation S602, the transmitting/receiving unit 420 of the online device 120 receives the certificate verification request message from the offline device 110 (Operation S603).

After Operation S603, the message generation unit 410 of the online device 120 extracts the nonce (generated by the offline device 110) from the message received by the transmitting/receiving unit 420, and generates an OCSP request message including the extracted nonce (Operation S604).

After Operation S604, the transmitting/receiving unit 420 of the online device 120 transmits the generated OCSP request message to the OCSP response server 130 (Operation S605).

After Operation S605, the transmitting/receiving unit 530 of the OCSP response server 130 receives the OCSP request message from the online device 120 (Operation S606).

After Operation S606, the verification unit 510 of the OCSP response server 130 verifies the certificate on the target online device according to the received OCSP request message (Operation S607).

After Operation S607, the response message generation unit 520 of the OCSP response server 130 generates an OCSP response message regarding the verification result of the certificate on the target online device (Operation S608).

The OCSP response message includes the nonce generated by the offline device 110. Then, the response message generation unit 520 can extract the nonce from the OCSP request message received from the online device 120.

After Operation S608, the transmitting/receiving unit 530 of the OCSP response server 130 transmits the generated OCSP response message to the online device 120 (Operation S609).

After Operation S609, the transmitting/receiving unit 420 of the online device 120 receives the OCSP response message from the OCSP response server 130 and transmits the received OCSP response message to the offline device 110 (Operation S610).

After Operation S610, the transmitting/receiving unit 320 of the offline device 110 receives the OCSP response message on the target online device from the online device 120 (Operation S611).

After Operation S611, the certificate verification result determination unit 330 of the offline device 110 extracts the nonce from the received OCSP response message and compares the extracted nonce with the nonce generated by the nonce generation unit 310 to determine whether the received OCSP response message is reliable (Operation S612).

Although the invention has been described in connection with the exemplary embodiments of the invention, it will be apparent to those skilled in the art that various modifications and changes may be made thereto without departing from the scope and spirit of the invention. Therefore, it should be understood that the above exemplary embodiments are not limiting, but illustrative in all aspects.

According to the above-described apparatus and method of verifying an online certificate for an offline device, the following effects can be obtained.

The OCSP that is only used for authentication between the online devices can be used for the offline device.

The OCSP response server manages information regarding the status of all of the associated certificates and maintains the latest information. Therefore, the OCSP can be safely used through an unreliable online device.

Problems, such as real-time updates, reduction in efficiency due to the size of the certificate revocation list (CRL), and vulnerability in the security when the offline device uses the CRL, can be resolved. Therefore, an efficient authentication method for a low-performance offline device can be provided.

Even if the offline device entrusts OCSP authentication to the online device subject to authentication, reliability of the certificate status verification result is ensured. Therefore, a load to generate the OCSP request message can be passed to the online device having relatively high performance. As a result, the amount of OCSP computing by a low-performance offline device can be reduced.

What is claimed is:

1. An apparatus for verifying an online certificate for an offline device, the apparatus comprising:
a nonce generation unit which generates a nonce and a certificate verification request message that requests verification of a certificate on a target online device subject to authentication, wherein the certificate verification request message includes the generated nonce;
a transmitting and receiving unit which transmits the certificate verification request to an online device and receives an online certificate status protocol (OCSP) response message from the online device; and a certificate verification result determination unit which extracts a nonce from the OCSP response and compares the extracted nonce with the nonce generated by the nonce generation unit to determine whether the OCSP response is reliable.

2. The apparatus of claim 1, wherein, if the extracted nonce and the generated nonce are consistent with each other, the certificate verification result determination unit determines that the received message is reliable.

3. An apparatus for verifying an online certificate for an offline device, the apparatus comprising:
a message generation unit which generates an online certificate status protocol (OCSP) request message according to a certificate verification request message that requests verification of a certificate on a target online device subject to authentication received from an offline device; and
a transmitting and receiving unit which transmits the OCSP request message to an OCSP response server, and receives an OCSP response message from the OCSP response server in response to the OCSP request message.

4. The apparatus of claim 3, wherein the OCSP request message includes a nonce generated by the offline device.

5. The apparatus of claim 3, wherein the transmitting and receiving unit transmits the OCSP response message received from the OSCP device to the offline device.

6. An apparatus for verifying an online certificate for an offline device, the apparatus comprising:
a verification unit verifying a certificate on a target online device according to an OCSP request message received from an online device;
a response message generation unit generating an OCSP response message on the verification result; and
a transmitting/receiving unit transmitting the generated message to the online device.

7. The apparatus of claim 6, wherein the generated OCSP response message includes a nonce generated by the offline device, and the offline device requests for verification of the certificate on the target online device.

8. A method of verifying an online certificate for an offline device, the method comprising:
generating a nonce;
generating a certificate verification request message that requests verification of a certificate on a target online device subject to authentication, wherein the certificate verification requested message includes the generated nonce;
transmitting the certificate verification request to an online device;
receiving an online certificate status protocol (OCSP) response message transmitted by the online device in response to the certification verification request message;
extracting a nonce from the OCSP response message;
comparing the extracted nonce with the generated nonce; and
determining whether the OCSP response message is reliable based on a result of the comparing.

9. The method of claim 8, wherein the determining whether the OCSP response message is reliable comprises determining that the received message is reliable if the result of the comparing indicates that the extracted nonce and the generated nonce are consistent with each other.

10. A method of verifying an online certificate for an offline device, the method comprising:
receiving a certificate verification request message that requests verification of a certificate on a target online device subject to authentication from an offline device;
generating an online certificate status protocol (OCSP) request message according to the certificate verification request message;
transmitting the OCSP request to an OCSP response server; and
receiving an OCSP response message in response to the OCSP request message from the OCSP response server.

11. The method of claim 10, wherein the certificate verification request message includes a nonce generated by the offline device, and the OCSP request message includes the nonce.

12. The method of claim 10, further comprising:
transmitting the OCSP response message to the offline device.

13. A method of verifying an online certificate for an offline device, the method comprising:
verifying a certificate on a target online device according to an online certificate status protocol (OCSP) request message received from an online device;
generating an OCSP response message based on a result of the verifying; and
transmitting the OCSP response message to the online device.

14. The method of claim 13, wherein the OCSP response message includes a nonce which is generated by an offline device and extracted from the OCSP request message.
